(19) United States
(12) Patent Application Publication
(10) Pub. No.: US 2019/0171976 A1
(43) Pub. Date: Jun. 6, 2019

(54) ENHANCEMENT OF COMMUNICATIONS TO A USER FROM ANOTHER PARTY USING COGNITIVE TECHNIQUES

(71) Applicant: INTERNATIONAL BUSINESS MACHINES CORPORATION, Armonk, NY (US)

(72) Inventors: Maharaj MUKHERJEE, Poughkeepsie, NY (US); Shikhar KWATRA, Morrisville, NC (US)

(73) Assignee: INTERNATIONAL BUSINESS MACHINES CORPORATION, Armonk, NY (US)

(21) Appl. No.: 15/832,936

(22) Filed: Dec. 6, 2017

(51) Int. Cl. G06N 99/00; G06Q 50/00; H04L 12/58

(52) U.S. Cl. CPC G06N 99/005; H04L 51/10; G06Q 50/01

(57) ABSTRACT

Embodiments for enhancing communications for a user by a processor. An appropriateness of communications may be learned for communicating with a user based on one or more disabilities relating to the user. One or more customized communications may be created based on the learned appropriateness of the communications for the user. The customized communications may be modified, adjusted, and/or polished based on reaction to the customized communications by the user, a caregiver of the user, or a combination thereof.

### BACKGROUND OF THE INVENTION

### Field of the Invention

The present invention relates in general to computing systems, and more particularly to, various embodiments for enhancing communications between a user and another party by a processor.

### Description of the Related Art

In today's society, consumers, businesspersons, educators, and others communicate over a wide variety of mediums in real time, across great distances, and many times without boundaries or borders. The advent of computers and networking technologies have made possible the intercommunication of people from one side of the world to the other. Smartphones and other sophisticated devices that rest in the palm of a person's hand allow for the sharing of information between users in an increasingly user friendly and simple manner. The increasing complexity of society, coupled with the evolution of technology continue to engender the sharing of a vast amount of information between people. For example, social media applications allow users to reach a large number of other persons, on a worldwide basis, that once was reserved for mass printed publications such as newspapers.

### SUMMARY OF THE INVENTION

Various embodiments for enhancing of communications to a user from another party using cognitive techniques by a processor, are provided. In one embodiment, by way of example only, a method for enhancing communications for a user, again by a processor, is provided. An appropriateness of communications may be learned for communicating with a user based on one or more disabilities relating to the user. One or more customized communications may be created based on the learned appropriateness of the communications for the user. The customized communications may be modified, adjusted, and/or polished based on reaction to the customized communications by the user, a caregiver of the user, or a combination thereof.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram depicting an exemplary cloud computing node according to an embodiment of the present invention;

FIG. 2 is an additional block diagram depicting an exemplary cloud computing environment according to an embodiment of the present invention;

FIG. 3 is an additional block diagram depicting abstraction model layers according to an embodiment of the present invention;

FIG. 4 is an additional block diagram depicting various user hardware and cloud computing components functioning in accordance with aspects of the present invention;

FIG. 5 is a flowchart diagram depicting an exemplary method for enhancing communications between a user and another party, in which various aspects of the present invention may be realized;

FIGS. 6A-6B is a diagram illustrating various examples of enhancing communications between a user and another party according to the present invention; and

FIG. 7 is an additional flowchart diagram depicting an additional exemplary method for enhancing communications, again in which various aspects of the present invention may be realized.

### DETAILED DESCRIPTION OF THE DRAWINGS

In today's interconnected and complex society, computers and computer-driven equipment are more commonplace. Processing devices, with the advent and further miniaturization of integrated circuits, have made it possible to be integrated into a wide variety of personal, business, health, home, education, entertainment, travel and other devices. Communication is further enhanced and improved by computers and wireless communication devices. Communications, such as media data (e.g., audio/video), emails, messages, speeches, social media posts, and other content may be provided to one or more users.

However, recipients of these communications may experience a variety of communication challenges, learning difficulties, and/or health related learning and communication disabilities. For example, sensory, perceptual, cognitive and/or emotional response problems in individuals may be associated with neural dysfunction. Examples include autism spectrum disorders (ASD or “autism”), epilepsy, dyslexia, attention deficit disorder (ADD), focal dystonia and obsessive/compulsive disorders (OCD), and/or post-traumatic stress disorder (“PTSD”).

More specifically, individuals with ASD may be fluently verbal but experience language, communication, and social interaction challenges and/or difficulties. The consequences of the ASD disorder may manifest as, for example, difficulties in communicating ideas, socializing and engaging with others, and in making eye-to-eye contact. For example, in some autistic individuals, some sensory challenges may include sensitivity to sound, lights, colors, specific words or expressions, quick change in audio or video data, and/or movement. For example, an autistic person may be hypersensitive to a specific frequency (or frequencies). An audible tone at a specific frequency may be uncomfortable and irritating to these autistic individuals even when presented at a sound level not perceived as being too loud by most individuals. As additional examples, an autistic person may also display difficulty attending to an auditory message if stressed, agitated, or highly stimulated. The autistic person may also ask repeated questions, be resistant to changes in routine or environment, experience difficulty in multi-tasking, prefer interpreting experiences or events in black and white or in concrete terms, and/or exhibit clinical obsessive-compulsive disorders, anxiety, depression, and/or mood disorders.

The presence and intensity of these challenges and/or disabilities characteristic of an individual with a neural dysfunction such as, for example, autism or ASD may vary by age and by individual. Persons without ASD often find difficulty in communicating and interacting with an individual afflicted with ASD. Often times, persons without ASD need to be trained on how best to appropriately communicate with the individual afflicted with ASD. Moreover, additional care, sensitivity, compassion, and control may need to be exhibited towards the individual afflicted with ASD during these times of communication by adjusting, modifying, and/or altering forms and styles of communication. Nevertheless, despite a party's best intentions, there are times that persons without ASD and without the proper training negatively impact the individual afflicted with ASD during a communication exchange.

As such, well-worded communication may be considered proper and appropriate for some individuals while also being improper and inappropriate for those individuals with a neural dysfunction. Accordingly, a need exists for a system that may conform all communication to an acceptable level of communication for any individual with a neural dysfunction. The so-called “appropriateness” of communication, such as a message, may be very subjective and context dependent particularly when a person without a neural dysfunction communicates with a person afflicted with a neural dysfunction. The same message may be interpreted and evaluated to be either “appropriate,” “inappropriate,” “suitable,” “non-suitable,” “proper,” or even “improper,” depending on who (subject) says to whom (object), when and where (context). In other words, the content of communication itself may not be inappropriate; rather the context of the communication becomes important as questions of to whom the communication is directed, who the communication is from, who may view the communication, where the communication is sent, and when the communication is sent.

Accordingly, the so-called “appropriateness” of a particular communication may depend greatly upon contextual factors, such as a subject-object relationship, and other contextual factors such as, for example, the audio or video frequency, color or lighting of video/image, communication speed, communication tone, patterns of communication, movements of objects or images of video data, and/or current socially sensitive topics relevant to a person challenged with communication/social skills, neural dysfunction, or other sensory, perceptual, cognitive and/or emotional/behavioral challenges, disabilities, or dysfunctions. A deeper, cognitive analysis of the communication is needed, for example based on standards, rules, and practices relating to persons with these various challenges.

The mechanisms of the illustrated embodiments provide enhancing mechanisms for enhancing communications for a user. An appropriateness of communications may be learned for communicating with a user based on one or more disabilities (e.g., autism) relating to the user. One or more customized communications may be created based on the learned appropriateness of the communications for the user. The customized communications may be enhanced (e.g., modified and/or polished according to learned appropriateness) based on reaction to the customized communications by the user, a caregiver of the user, or a combination thereof. It should be noted that any reference to an individual afflicted with autism, as described herein, may also refer to and/or include any person having any sensory, perceptual, cognitive, emotional/behavioral challenges, disabilities, or dysfunctions (e.g., neural dysfunction), and/or any other difficulties in communicating or engaging in social interaction with other persons. As such, as used herein, the use of the word “autism” or phrase “individual afflicted with autism” may include or make reference to any one of these challenges, deficiencies, difficulties, disabilities, and/or dysfunctions.

The present invention may learn and recognize any communication (e.g., audio or video data) interaction with individuals having sensory, perceptual, cognitive and/or emotional/behavioral challenges, disabilities, or dysfunctions that may be inappropriate, improper, and/or intolerable. The present invention may filter and remove those sections, segments, or portions of the communication, which may create discomfort to an individual, such as, for example, an autistic person.

For example, an autistic person may be sensitive to the color “yellow.” For those cases, the present invention may remove any yellow tone or bright colors from the image. An enhancing operation (via an enhancing component) may be used to analyze the communication (e.g., a real-time video conversation) and perform a natural language processing (NLP) and artificial intelligence (AI) operation to transcribe the speech language to a text form while using a knowledge domain (e.g., knowledge base) of the respective eccentric emotions and/or behaviors and characteristics of the autistic individual involved in the conversation. That is, any spoken language may be translated and/or transcribed into text form with one or more modifications (e.g., adjusting of the frequency, colors, word, etc.) to an understandable and comfortable format after dynamically enhancing (e.g., modifying, editing, adjusting, and/or polishing) the spoken words in an autistic user's friendly format. The transcribed text data may be adjusted to ensure suitability for all parties involved in the conversation.

In one embodiment, for example, the present invention cognitively learns the special needs, preferences, and/or sensitivities for an autistic person. The present invention creates an audio and video filter mechanism using deep learning mechanism to create and filter out unacceptable, inappropriate, and/or intolerable colors, frequency (both audio and video) words, video, etc. In order to create the filter, the present invention starts with a knowledge domain for persons afflicted with any sensory, perceptual, cognitive, emotional/behavioral challenges, disabilities, or dysfunctions (e.g., a neural dysfunction such as autism), and may customize the knowledge domain for each respective person. A mood detection operation may be used to learn acceptable or tolerable communication styles, communication patterns, communication speed, languages, audio/video frequency, colors, words, or other sensitivities to color, light, speech, audio, video, or communication topics. Feedback may be collected from caregivers, associates, or persons associated with the autistic person to further augment and/or fine tune the filter.

In addition, the mechanisms of the illustrated embodiments provide guidance to a communicator communicating with an autistic person. For example, the guidance may include indicating or suggestion to a communicator how to appropriately communicate with the autistic person such as, for example, providing guidance on how to phrase a question. For example, the guidance on “how to phrase a question” may indicate or suggest adding the name of the autistic person before starting the communication such as, for example, “John Doe, how are you today?” The guidance may also include suggestions to avoid unacceptable or intolerable language particular to the autistic person. The present invention may include repeating all or various portions of the communication as appropriate for the autistic person. For example, a question from the communicator (e.g., person not afflicted with autism) may be automatically repeated until a response is received from the autistic person. The present invention may also provide advice or suggestions to the communicator to stop the communication at one or more selected time periods such as, for example, stopping the communication during the time period of receiving the advice or guidance. The present invention may also suggest to the communicator to create a low frequency (both audio and video) environment before starting any communication with the autistic person so as to enable the increasing of the efficiency of the enhancing operation.

In an additional aspect, cognitive or “cognition” may refer to a mental action or process of acquiring knowledge and understanding through thought, experience, and one or more senses using machine learning (which may include using sensor based devices or other computing systems that include audio or video devices). Cognitive may also refer to identifying patterns of emotions and/or behaviors, leading to a “learning” of one or more events, operations, or processes. Thus, the cognitive model may, over time, develop semantic labels to apply to observed emotions and/or behaviors and use a knowledge domain or ontology to store the learned observed emotions and/or behaviors. In one embodiment, the system provides for progressive levels of complexity in what may be learned from the one or more events, operations, or processes.

In an additional aspect, the term cognitive may refer to a cognitive system. The cognitive system may be a specialized computer system, or set of computer systems, configured with hardware and/or software logic (in combination with hardware logic upon which the software executes) to emulate human cognitive functions. These cognitive systems apply human-like characteristics to convey and manipulate ideas which, when combined with the inherent strengths of digital computing, can solve problems with a high degree of accuracy (e.g., within a defined percentage range or above an accuracy threshold) and resilience on a large scale. A cognitive system may perform one or more computer-implemented cognitive operations that approximate a human thought process while enabling a user or a computing system to interact in a more natural manner. A cognitive system may comprise artificial intelligence logic, such as natural language processing (NLP) based logic, for example, and machine learning logic, which may be provided as specialized hardware, software executed on hardware, or any combination of specialized hardware and software executed on hardware. The logic of the cognitive system may implement the cognitive operation(s), examples of which include, but are not limited to, question answering, identification of related concepts within different portions of content in a corpus, and intelligent search algorithms, such as Internet web page searches.

In general, such cognitive systems are able to perform the following functions: 1) Navigate the complexities of human language and understanding; 2) Ingest and process vast amounts of structured and unstructured data; 3) Generate and evaluate hypotheses; 4) Weigh and evaluate responses that are based only on relevant evidence; 5) Provide situation-specific advice, insights, estimations, determinations, evaluations, calculations, and guidance; 6) Improve knowledge and learn with each iteration and interaction through machine learning processes; 7) Enable decision making at the point of impact (contextual guidance); 8) Scale in proportion to a task, process, or operation; 9) Extend and magnify human expertise and cognition; 10) Identify resonating, human-like attributes and traits from natural language; 11) Deduce various language specific or agnostic attributes from natural language; 12) Memorize and recall relevant data points (images, text, voice) (e.g., a high degree of relevant recollection from data points (images, text, voice) (memorization and recall)); and/or 13) Predict and sense with situational awareness operations that mimic human cognition based on experiences.

In an additional aspect, the knowledge domain may be an ontology of concepts representing a domain of knowledge. A thesaurus or ontology may be used as the domain knowledge and may also be used to associate various characteristics, attributes, symptoms, behaviors, sensitivities, parameters, clinical diagnoses and treatments of an individual afflicted with autism or person having any sensory, perceptual, cognitive, emotional/behavioral challenges, disabilities, or dysfunctions (e.g., neural dysfunction), and/or any other difficulties in communicating or engaging in social interaction with other persons. In one aspect, the term “domain” is a term intended to have its ordinary meaning. In addition, the term “domain” may include an area of expertise for a system or a collection of material, information, content and/or other resources related to a particular subject or subjects.

The term ontology is also a term intended to have its ordinary meaning. In one aspect, the term ontology in its broadest sense may include anything that can be modeled as ontology, including but not limited to, taxonomies, thesauri, vocabularies, and the like. For example, an ontology may include information or content relevant to a domain of interest or content of a particular class or concept. The ontology can be continuously updated with the information synchronized with the sources, adding information from the sources to the ontology as models, attributes of models, or associations between models within the ontology.

Other examples of various aspects of the illustrated embodiments, and corresponding benefits, will be described further herein.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

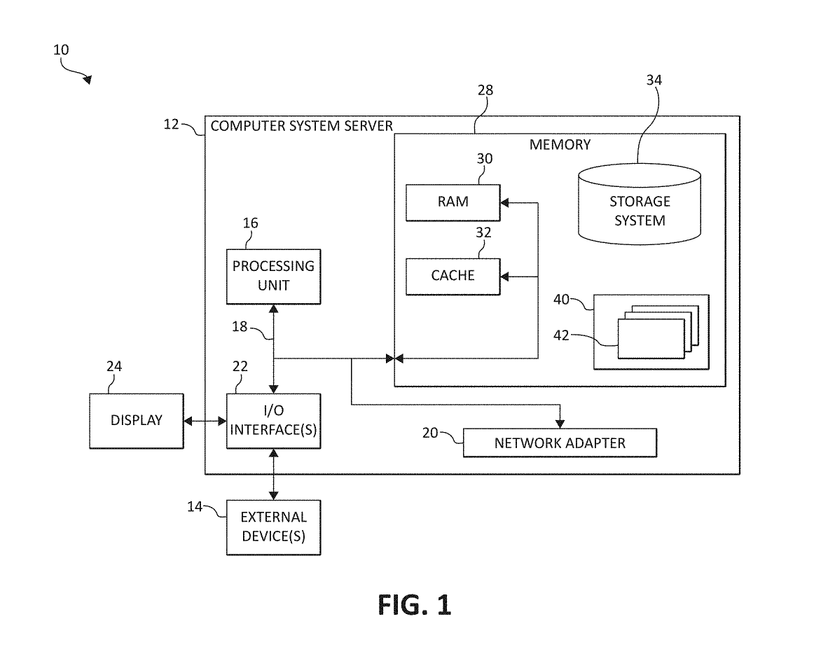

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, system memory 28 may include at least one program product having a set (e.g., at least one) of program modules that are configured to carry out the functions of embodiments of the invention.

Program/utility 40, having a set (at least one) of program modules 42, may be stored in system memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

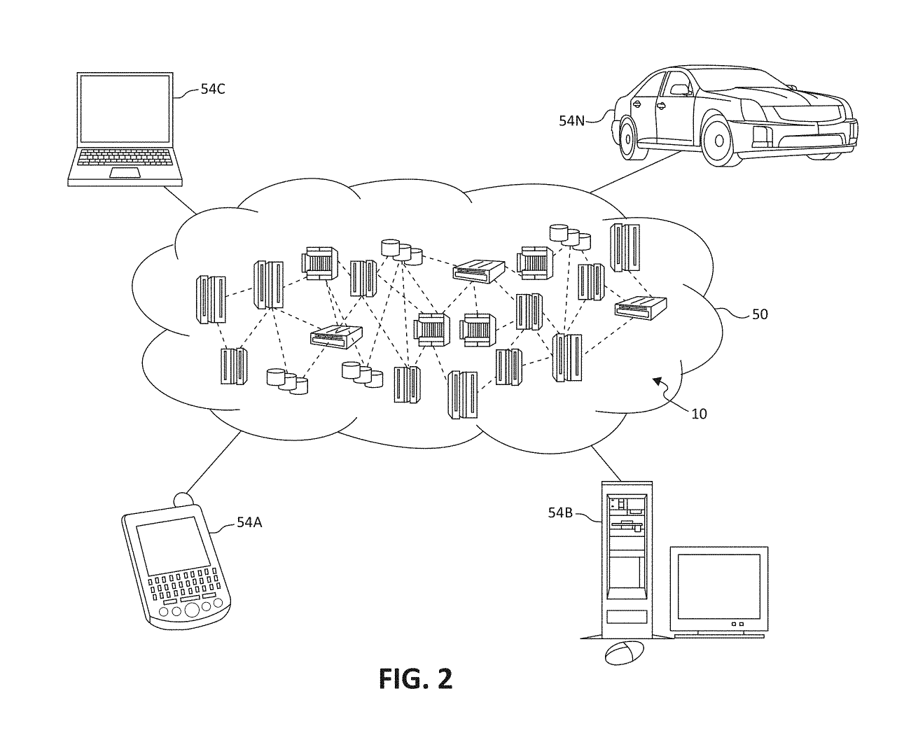

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

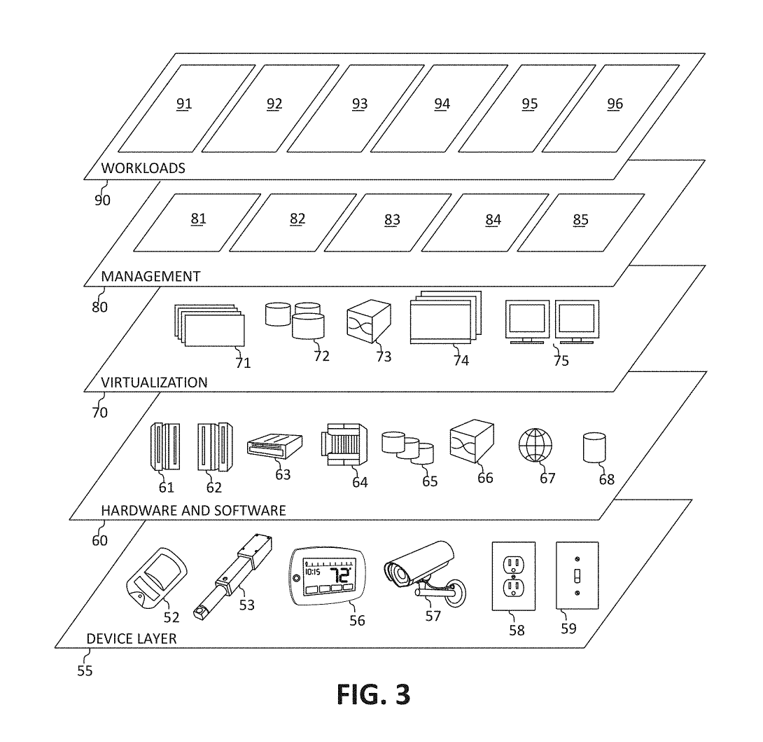

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, in the context of the illustrated embodiments of the present invention, various communication processing and enhancing workloads and functions 96. In addition, communication processing and enhancing workloads and functions 96 may include such operations as data analytics, data analysis, and as will be further described, notification functionality. One of ordinary skill in the art will appreciate that the communication processing workloads and functions 96 may also work in conjunction with other portions of the various abstractions layers, such as those in hardware and software 60, virtualization 70, management 80, and other workloads 90 (such as data analytics processing 94, for example) to accomplish the various purposes of the illustrated embodiments of the present invention.

As previously mentioned, the mechanisms of the illustrated embodiments provide novel approaches for the monitoring and dissemination of communications to safeguard a user against submitting communication that the user may later regret to have submitted. These mechanisms include functionality that creates a filter component to filter communication and create audio and visual output that is suitable and/or appropriate for a recipient. The filter may interpret the content of a particular communication in terms of identified factors relating to individuals afflicted with autism, verifies an “appropriateness” of the communication, and filters the communication when the content of the communication in a certain setting could have potentially negative implications upon the recipient.

A cognitive learning and adjustment operation may be provided to modify the filter based on a recipient's reaction to certain audio and visual output based on either automated reaction and detection of the recipient and/or from a caregiver or person associated with the recipient. The present invention may provide guidance to the communicator to modify the style, tone, and/or speed of the communication.

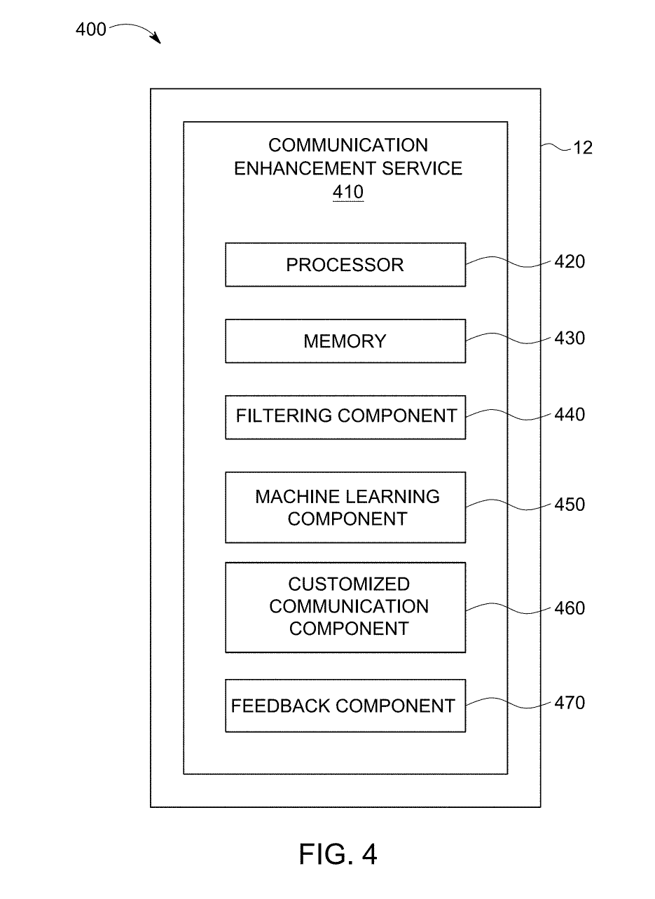

Turning now to FIG. 4, a block diagram depicting exemplary functional components 400 according to various mechanisms of the illustrated embodiments is shown. In one aspect, one or more of the components, modules, services, applications, and/or functions described in FIGS. 1-3 may be used in FIG. 4. A communication enhancement service 410 is shown, incorporating processing unit 420 to perform various computational, data processing and other functionality in accordance with various aspects of the present invention. The communication enhancement service 410 may be provided by the computer system/server 12 of FIG. 1. The processing unit 420 may be in communication with memory 430. The communication enhancement service 410 may include an enhancing component 440, a machine learning component 450, a customized communication component 460, and a feedback component 470.

As one of ordinary skill in the art will appreciate, the depiction of the various functional units in communication enhancement service 410 is for purposes of illustration, as the functional units may be located within the communication enhancement service 410 or elsewhere within and/or between distributed computing components.

In one aspect, the enhancing component 440 may filter communications intended for a user (e.g., an individual afflicted with autism) using an enhancing operation using a knowledge domain. The enhancing component 440 may modify, polish, and/or adjust the color of video data (e.g., an image), provide frequency smoothing of audio or video, audio smoothing and noise removal, and/or simply text data to a format suitable to the user with autism.

The machine learning component 450 may learn an appropriateness of communications for communicating with the user based on one or more disabilities (e.g., social skills, communication skills, neural dysfunctions, and the like) relating to the user. The machine learning component 450 may be used to assist with and/or create an audio and video enhancing operation via the enhancing component 440 using a machine learning operation to filter and/or enhance from the communications any unacceptable audio data, video data, colors from the video data, audio frequency, video frequency, text data, or a combination thereof relating to the user.

The customized communication component 460, in association with the enhancing component 440, may create customized communications based on the learned appropriateness of the communications for the user and/or modify the customized communications based on reaction to the customized communications by the user, a caregiver of the user, or a combination thereof. In one aspect, the customized communication component 460 may create one or more media communications (from the communication provided to the user) based on the learned appropriateness of the communications. The media communications include text data, audio data, video data, an image, or a combination thereof. For example, the customized communication component 460 may provide an NLP operation to analyze and interpret speech communication. The customized communication component 460 may translate and/or transcribe video data into text form with one or more modifications (e.g., adjusting of the frequency, colors, word, etc.) to an understandable and comfortable format after dynamically enhancing the spoken words in an appropriate format suitable to the individual with autism.

The feedback component 470 may be used to collect feedback information from the user, the caregiver of the user, or a combination thereof. Also, the feedback component 470 may provide one or more suggestions to an entity providing the communications, so as to modify a communication style, a communication tone, a speed of communication, communication patterns, color, frequency, sound, video/image, or other areas of sensitivity bearing upon the comfort/discomfort of an individual afflicted with autism, and/or a combination thereof suitable to the user.

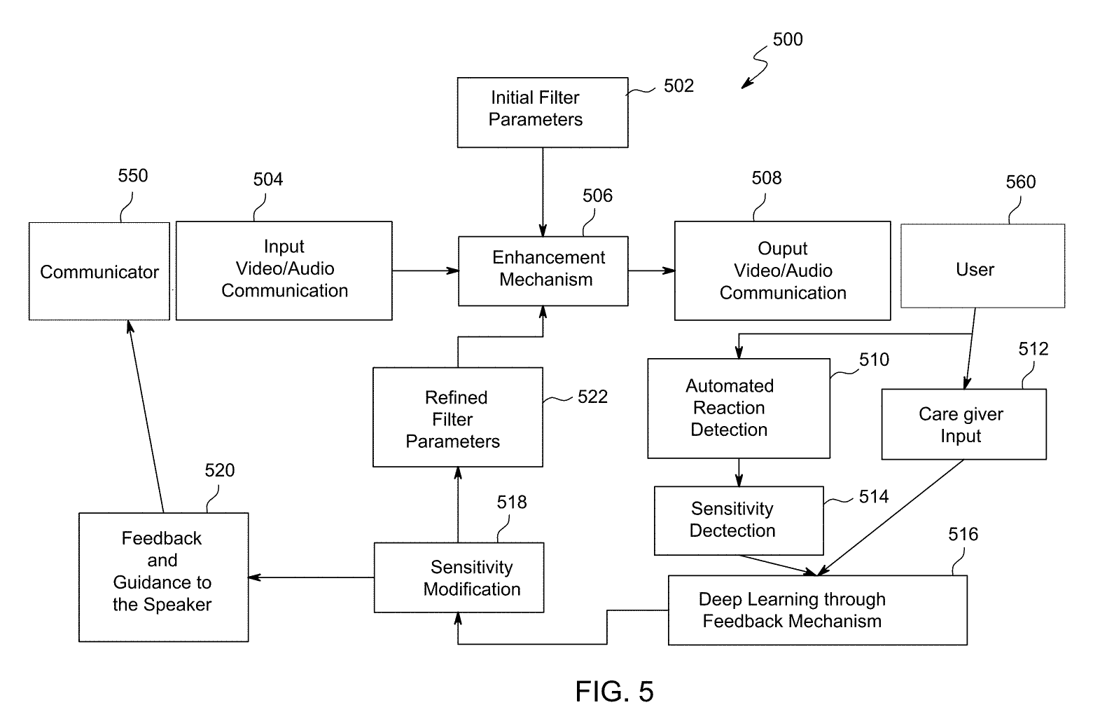

Turning now to FIG. 5, a flowchart of an exemplary method for facilitating communications by a processor is depicted, in which various aspects of the present invention may be implemented. Method 500 begins (steps 502 and 504) by cognitively learning enhancing parameters (or receiving the enhancing parameters from a knowledge domain) and receiving input of audio and/or video communication. An enhancing mechanism may apply the enhancing parameters to the received audio and/or video communication (step 506). The enhancing mechanism may output audio and/or video communication (which may be customized communication) for a user 560 (e.g., a user afflicted with autism) (step 508). A reaction to and/or response to the customized communication from the user 560 may be automatically detected (e.g., automated reaction and/or detection) (step 510). That is, a feedback response of the user to the customized communication may be automatically collected. Moreover, a feedback response of the user 560 to the customized communication may be automatically collected from a caregiver (e.g., caregiver input) and/or person associated with the user (step 512), and provided as input to step 516. For example, the caregiver may notice that the user 560 becomes agitated upon observing a color in the video communication and the caregiver may indicate, for example, that the user 560 “has become extremely agitated.” The sensitivity of the user to the customized communication may be detected (and provided as input to step 516) (step 514). A deep learning operation may be learned via a machine learning operation (e.g., a feedback mechanism) by receiving the collected feedback and sensitivity detection data (step 516).

The customized communication may be modified or adjusted according to the deep learning operation (step 518) (e.g., sensitivity modification). That is, the customized communication may be modified to adapt or adjust to the learned sensitivities of the user (e.g., the individual afflicted with autism). Feedback and guidance may be provided to the communicator 550 (e.g., speaker or individual not afflicted with autism) (step 520). Also, the filter parameters may be refined using the learned sensitivities of the user 560 (step 522). The refined filter parameters (of step 522) may be used by the filter mechanism (in step 506).

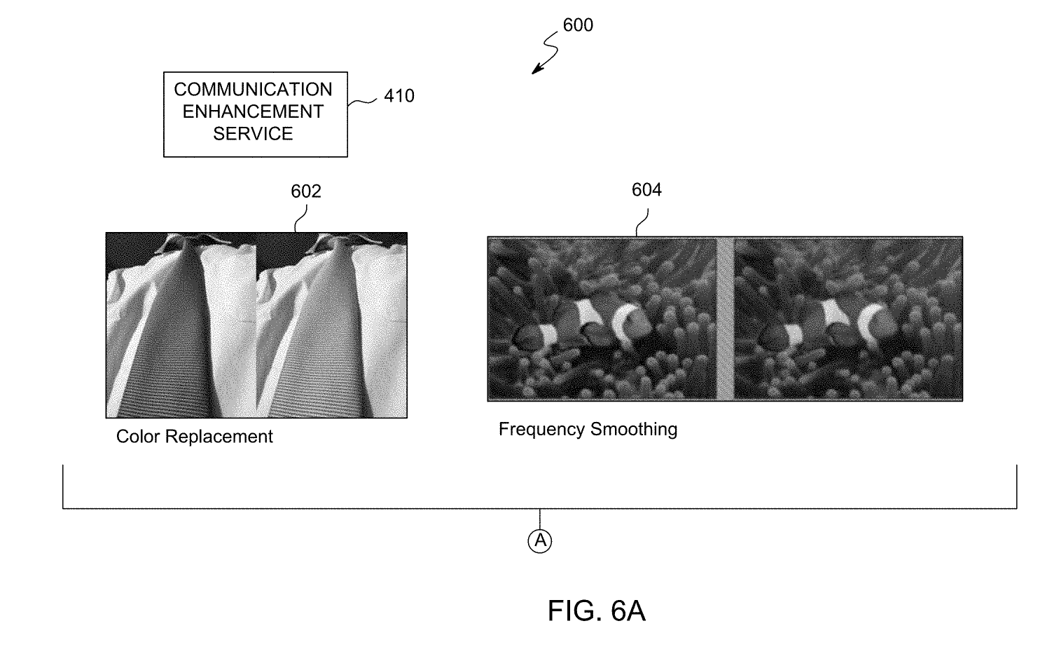

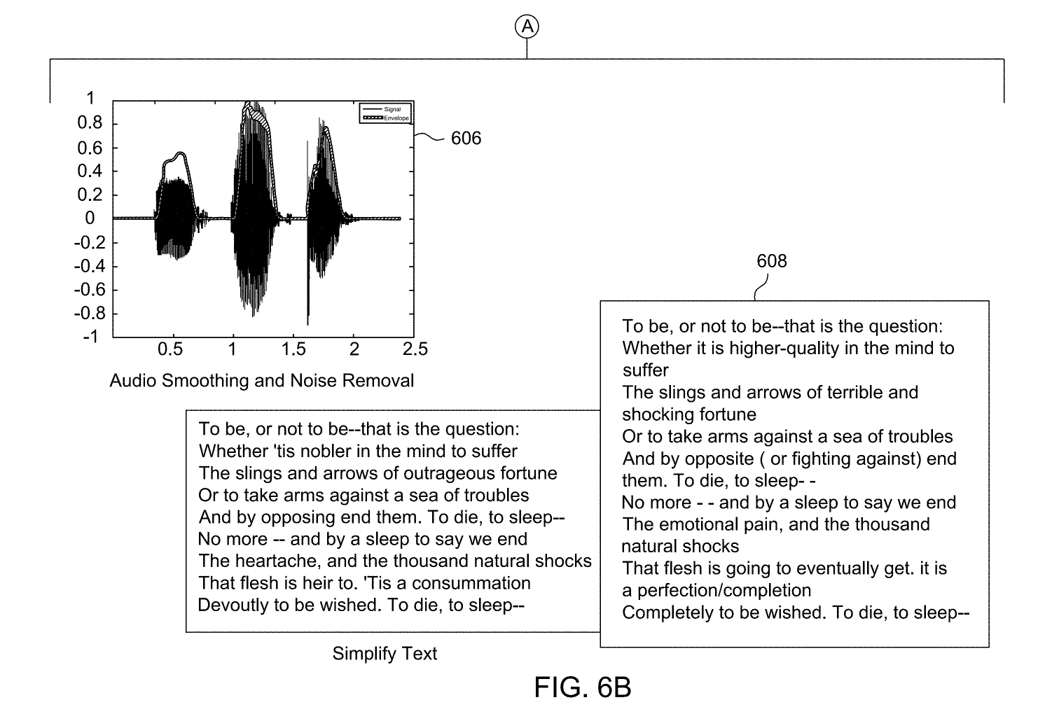

FIGS. 6A-6B is a diagram illustrating various examples 600 of enhancing communications between a user and another party. In one aspect, the functionality, operations, and/or architectural designs of FIGS. 1-5 may be implemented all and/or in part in FIGS. 6A-6B.

More specifically, the communication enhancement service 410 may be provided for one or more enhancing operations. For example, in one aspect, the communication enhancement service 410 may learn one or more enhancing parameters (e.g., parameters such as, for example, sensitivities to color, light, sound, movement, etc.) having a negative or positive impact upon the autistic person. Also, the communication enhancement service 410 may use a knowledge domain having one or more standardized enhancing parameters associated with an autistic person.

In one example, the communication enhancement service 410 may analyze video/image data 602 and detect a color (e.g., orange) that causes discomfort to the user. The communication enhancement service 410 may then enhance the color to modify, polish, and/or adjust the color to a color appropriate and suitable for an autistic person (e.g., change from orange to green).

In an additional example, the communication enhancement service 410 may analyze video/image data 604 and determine a video frequency that causes discomfort to the user. The communication enhancement service 410 may then enhance the video/image data 604 to smooth (e.g., frequency smoothing) the video frequency to enable the video/image data 604 to be appropriate and suitable for the autistic person.

Moreover, the communication enhancement service 410 may analyze audio data 606 and determine an audio frequency or an amount of audible “noise” that causes discomfort to the user. The communication enhancement service 410 may then filter the audio data 606 to smooth (e.g., audio smoothing) the audio frequency and/or remove noise from the audio to enable the audio data 606 to be appropriate and suitable for the autistic person.

As an additional example, the communication enhancement service 410 may analyze text data 608 and determine the text data causes discomfort to the user. The communication enhancement service 410 may then filter the text data 608 to modify, adjust, alter, reorganize, and/or translate the text data into a style, pattern, or suitability appropriate for the autistic person.

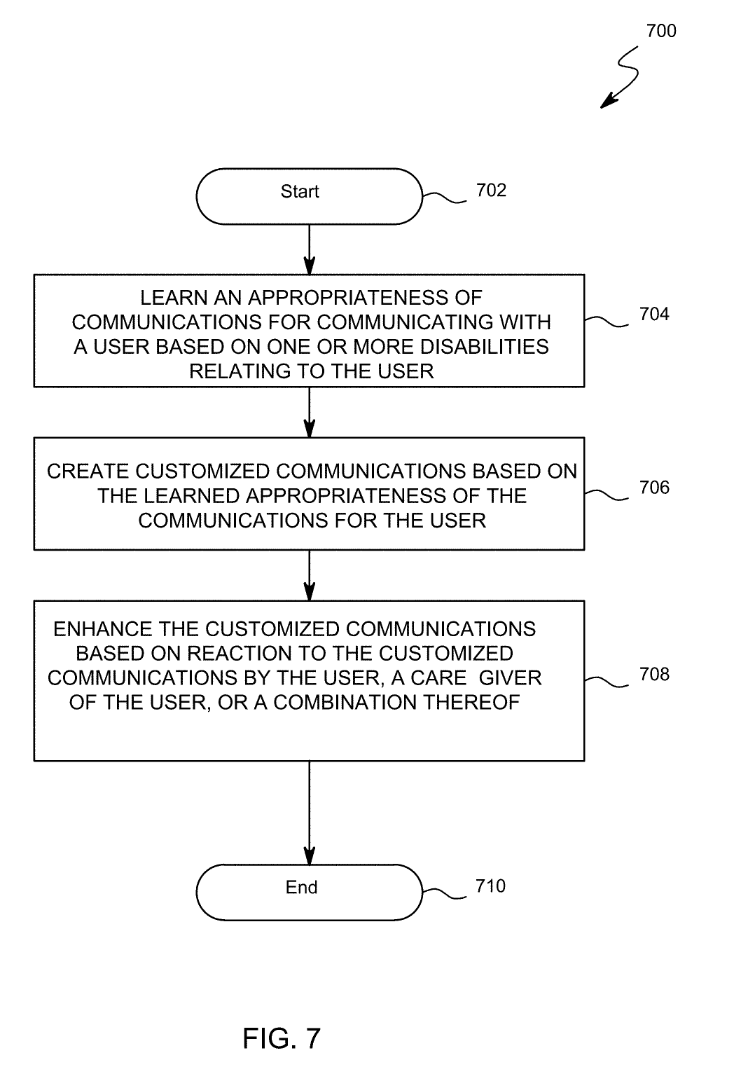

Turning now to FIG. 7, a method 700 for enhancing communications for a user using a processor is depicted, in which various aspects of the illustrated embodiments may be implemented. The functionality 700 may be implemented as a method executed as instructions on a machine, where the instructions are included on at least one computer readable medium or one non-transitory machine-readable storage medium. In one aspect, the functionality, operations, and/or architectural designs of FIGS. 1-5 may be implemented all and/or in part in FIG. 7.

The functionality 700 may start in block 702. An appropriateness of communications may be learned for communicating with a user based on one or more disabilities relating to the user, as in block 704. One or more customized communications may be created based on the learned appropriateness of the communications for the user, as in block 706. The customized communications may be enhanced (e.g., edited, modified, adjusted, and/or polished) based on reaction to the customized communications by the user, a caregiver of the user, or a combination thereof, as in block 708. The functionality 700 may end, as in block 710.

In one aspect, in conjunction with and/or as part of at least one block of FIG. 7, the operations of method 700 may include each of the following. The operations of method 700 may, pursuant to creating the customized communications, filter the communications for the user using an enhancing operation using a knowledge domain. The operations of method 700 may, pursuant to creating the customized communications, create one or more media communications based on the learned appropriateness of the communications. The media communications may include text data, audio data, video data, an image, or a combination thereof.

The operations of method 700 may create an audio and video enhancing operation using a machine learning mechanism to enhance (e.g., edit, modify, polish, and/or adjust) from the communications any unacceptable audio data, video data, colors from the video data, audio frequency, video frequency, text data, or a combination thereof. Additionally, one or more suggestions may be provided to an entity (e.g., an alternative user, a caregiver associated with the user, an associate of the user, etc.) that may be providing the communications, so as to modify a communication style, a communication tone, a speed of communication, communication patterns, or a combination thereof suitable to the user.

The operations of method 700 may initialize a machine learning mechanism for 1) learning the appropriateness of the communications for the user, and/or 2) learning acceptable communication styles, communication tones, language type, communication speed, communication patterns, or a combination thereof suitable to the user. Also, feedback information may be collected and gathered from the user, the caregiver of the user, or a combination thereof.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowcharts and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowcharts and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowcharts and/or block diagram block or blocks.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

1. A method for enhancing communications for a user by a processor, comprising:
learning an appropriateness of communications for communicating with a user based on one or more disabilities relating to the user;
creating customized communications based on the learned appropriateness of the communications for the user; and
modifying the customized communications based on reaction to the customized communications by the user, a caregiver of the user, or a combination thereof.

2. The method of claim 1, wherein creating the customized communications further includes enhancing the communications for the user using an enhancing operation using a knowledge domain.

3. The method of claim 1, wherein creating the customized communications further includes creating one or more media communications based on the learned appropriateness of the communications, wherein the media communications include text data, audio data, video data, an image, or a combination thereof.

4. The method of claim 1, further including creating an audio and video enhancing operation using a machine learning mechanism to filter from the communications any unacceptable audio data, video data, colors from the video data, audio frequency, video frequency, text data, or a combination thereof.

5. The method of claim 1, further including providing one or more suggestions to an entity providing the communications so as to modify a communication style, a communication tone, a speed of communication, communication patterns, or a combination thereof suitable to the user.

6. The method of claim 1, further including initializing a machine learning mechanism for:
learning the appropriateness of the communications for the user; and
learning acceptable communication styles, communication tones, language type, communication speed, communication patterns, or a combination thereof suitable to the user.

7. The method of claim 1, further including collecting feedback information from the user, the caregiver of the user, or a combination thereof.

8. A system for enhancing communications, comprising:
one or more computers with executable instructions that when executed cause the system to:
learn an appropriateness of communications for communicating with a user based on one or more disabilities relating to the user;
create customized communications based on the learned appropriateness of the communications for the user; and
modify the customized communications based on reaction to the customized communications by the user, a caregiver of the user, or a combination thereof.

9. The system of claim 8, wherein the executable instructions, pursuant to creating the customized communications, filter the communications for the user using an enhancing operation using a knowledge domain.

10. The system of claim 8, wherein the executable instructions, pursuant to creating the customized communications, create one or more media communications based on the learned appropriateness of the communications, wherein the media communications include text data, audio data, video data, an image, or a combination thereof.

11. The system of claim 8, wherein the executable instructions create an audio and video enhancing operation using a machine learning mechanism to filter from the communications any unacceptable audio data, video data, colors from the video data, audio frequency, video frequency, text data, or a combination thereof.

12. The system of claim 8, wherein the executable instructions provide one or more suggestions to an entity providing the communications so as to modify a communication style, a communication tone, a speed of communication, communication patterns, or a combination thereof suitable to the user.

13. The system of claim 8, wherein the executable instructions initialize a machine learning mechanism for:
learning the appropriateness of the communications for the user; and
learning acceptable communication styles, communication tones, language type, communication speed, communication patterns, or a combination thereof suitable to the user.

14. The system of claim 8, wherein the executable instructions collect feedback information from the user, the caregiver of the user, or a combination thereof.

15. A computer program product for enhancing communications for a user by a processor, the computer program product comprising a non-transitory computer-readable storage medium having computer-readable program code portions stored therein, the computer-readable program code portions comprising:
an executable portion that learns an appropriateness of communications for communicating with a user based on one or more disabilities relating to the user;
an executable portion that creates customized communications based on the learned appropriateness of the communications for the user; and
an executable portion that modifies the customized communications based on reaction to the customized communications by the user, a caregiver of the user, or a combination thereof.

16. The computer program product of claim 15, further including an executable portion that, pursuant to creating the customized communications:
filters the communications for the user using an enhancing operation using a knowledge domain; and
creates one or more media communications based on the learned appropriateness of the communications, wherein the media communications include text data, audio data, video data, an image, or a combination thereof.

17. The computer program product of claim 15, further including an executable portion that creates an audio and video enhancing operation using a machine learning mechanism to filter from the communications any unacceptable audio data, video data, colors from the video data, audio frequency, video frequency, text data, or a combination thereof.

18. The computer program product of claim 15, further including an executable portion that provides one or more suggestions to an entity providing the communications so as to modify a communication style, a communication tone, a speed of communication, communication patterns, or a combination thereof suitable to the user.

19. The computer program product of claim 15, further including an executable portion that initializes a machine learning mechanism for:
learning the appropriateness of the communications for the user; and
learning acceptable communication styles, communication tones, language type, communication speed, communication patterns, or a combination thereof suitable to the user.

20. The computer program product of claim 15, further including an executable portion that collects feedback information from the user, the caregiver of the user, or a combination thereof.
